(19) United States
(12) Patent Application Publication
(10) Pub. No.: US 2024/0265435 A1
(43) Pub. Date: Aug. 8, 2024

(54) SOCIAL SHOPPING LIST MESSAGE AND PAYMENT AUTHORIZATION

(71) Applicant: Toshiba Global Commerce Solutions, Inc., Durham, NC (US)

(72) Inventors: Brad M. JOHNSON, Raleigh, NC (US); David A. BERNATH, Cary, NC (US); J. Wacho SLAUGHTER, Raleigh, NC (US)

(21) Appl. No.: 18/164,463

(22) Filed: Feb. 3, 2023

(51) Int. Cl. G06Q 30/0601

(52) U.S. Cl. CPC G06Q 30/0637; G06Q 30/0639

(57) ABSTRACT

Embodiments of the present disclosure provide techniques for purchasing preauthorized items from a shared shopping list. Multiple users can add items to the shared shopping list and preauthorize other users to purchase the items on their behalf. When a user purchases an item from the list on behalf of another member using a mobile shopping app, the app can automatically purchase the item using funds (e.g., a credit card or bank account) of the member who added the item to the shared shopping list.

### BACKGROUND

Many different applications (apps) and built-in features on mobile devices permit multiple uses to share lists (e.g., shopping lists). When in a store, a person can check a shared shopping list to see if any other member of a group wants an item from the store. This works well for members of the same household (with shared finances). For example, a wife can add items to the shared list which her husband can purchase at the store. However, buying items for a person in another household adds the additional complexity of being reimbursed for the purchase. For example, if neighbors are part of a shared shopping list, when a first neighbor buys an item for a second neighbor, not only do they have to arrange delivery, but the second neighbor has to reimburse the first neighbor. In an increasing cashless society, providing payment is more complex and can require the use of another third party app. Moreover, it forces the first neighbor to essentially front the money for the second neighbor (e.g., serve as a bank) when purchasing an item from a shared shopping list.

### BRIEF DESCRIPTION OF THE DRAWINGS

FIG. 1 depicts a first example environment, according to one embodiment.

FIG. 2 depicts a second example environment, according to one embodiment.

FIG. 3 is a flow diagram for purchasing preauthorized items from a shared shopping list.

FIG. 4 is a flow diagram for providing receipts.

FIG. 5 is a flow diagram for updating a shared shopping list.

### DETAILED DESCRIPTION

Embodiments of the present disclosure provide techniques for purchasing preauthorized items from a shared shopping list. As stated above, conventional techniques lead to frustration of customers, especially when attempting to reimburse members of the shared shopping list who purchase items on behalf other members. Reimbursement can include keeping large amounts of cash on hand or using a separate app to provide payment. Moreover, until being reimbursed, the purchasing member has to fund the purchase which can affect their ability to purchase items they may want.

### Advantages of Using Preauthorization When Purchasing Items from a Shared Shopping List

The embodiments here provide techniques for preauthorizing purchases so that one member of a shared shopping list can purchase items on behalf of another member of the list, using funds controlled by the other member. This completely avoids the reimbursement process since the member buying the item does not pay for the item, instead using funds controlled by the person who wants the item. This also means the purchasing member does not have to use their own funds. For example, the item can be paid for using a credit card or bank account controlled by the member who added the item to the shopping list.

The present disclosure provides an improvement to the specific technology of mobile shopping systems. These improved systems can obtain preauthorization for members in a shared shopping list to purchase items for another member. When a member purchases an item from the list on behalf of another member using a mobile shopping app on a mobile device, the app can automatically deduct the funds to pay for the item from the member who added the item to the list (e.g., from a bank account, a credit card, or a transaction on a blockchain). This avoids any reimbursement process and the member at the store does not have to pay for the item using their own funds.

In addition to preauthorizing purchases, a mobile shopping app can provide notifications to the member at the store regarding items on the shared shopping list. For example, when a member scans an item using the mobile shopping app to purchase an item for themselves, the app can scan the list to determine whether other members want that same item. If so, the mobile shopping app can notify the member who can scan another one of the item (or items) and add it to their physical and virtual shopping cart. In another example, the app may determine when the member is at a location in the store near an item desired by a member and push a notification to the member. Or the app may determine when the member purchases an item that is typically stocked near an item on the shared shopping list (e.g., the member purchased toilet paper which is typically stocked near paper towels, which is on the shared shopping list). In yet another example, the mobile shopping app can push notifications to members who are not currently shopping. For example, if the app determines that a member has entered a store, the app can push notifications to members not shopping to give them a chance to quickly add items to the shared shopping list.

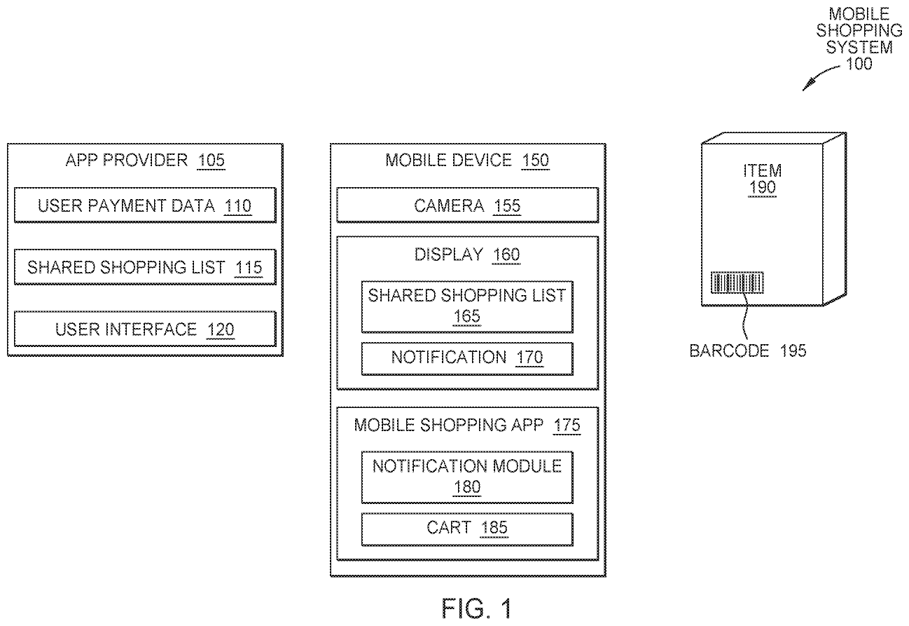

FIG. 1 illustrates a mobile shopping system 100. The system 100 includes an app provider 105, a mobile device 150, and an item 190 for purchase. The app provider 105 can be a backend computing system (or systems) such as one or more servers, data centers, cloud computing environments, and the like. The computing system can include computer processors and memory for executing and storing user payment data 110, shared shopping list 115, and a user interface 120.

The user payment data 110 can be used to preauthorize the purchase of items that members add to the shared shopping list 115. In one embodiment, when adding an item to the shopping list 115, the app provider 105 automatically preauthorizes another member who is part of the shopping list 115 to purchase the item on behalf of the member adding the item. In one embodiment, the member can specify a maximum value they are willing to pay for the item. In that case, the member who is currently shopping is preauthorized to purchase the item (using funds controlled by the member who add the item to the list 115) for up to the maximum value.

When a member attempts to purchase an item from the list 115, the app provider 105 can use the user payment data 110 to pay for the item so the member at the store does not have to pay for the item using their own funds. For example, the user payment data 110 can include credit card information, a checking account, or a blockchain. The app provider 105 can use the user payment data 110 to pay for the item using funds controlled by the member who added the item to the list 115.

The user interface 120 permits the app provider 105 to communicate with a mobile shopping app 175 installed on the mobile device 150. For example, the user interface 120 can permit the app provider 105 to receive the user payment data 110 from the members, receive items to add to the shared shopping list 115, and push notifications to the mobile devices 150.

The mobile device 150 includes a camera 155, a display 160, and a mobile shopping app 175. Although not shown, the mobile device 150 can include one or more computer processors and memory for performing the functions described herein. In one embodiment, a user can use the camera 155 to capture images of the item 190 they wish to purchase, and in this example, capture an image of a barcode 195 on the item 190 or use object recognition. The mobile shopping app 175 can decode the barcode 195 to identify the item 190 being purchased by the user. For example, the user may walk through a store and use the mobile device 150 to capture images of items they wish to purchase, which the mobile shopping app 175 adds to a virtual shopping cart 185. Thus, the mobile shopping app 175 permits the user to purchase items (their own items as well as items on the shared shopping list) without having to use a checkout kiosk at the store.

While the embodiments herein describe using a camera 155 to enable the mobile shopping app 175 to add items to the cart 185, other technologies could be used such as radio frequency identification (RFID). Further, a machine learning algorithm could be used by the mobile shopping app 175 to identify the item 190 rather than relying on a barcode 195, which can be used when purchasing an item which may not have barcodes 195 (e.g., fresh fruit or vegetables).

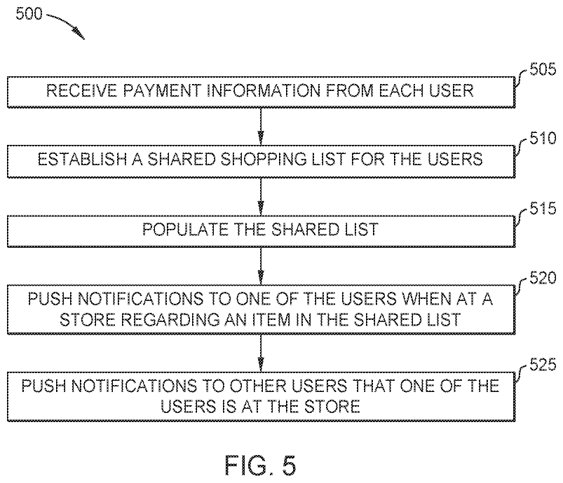

The display 160 can output the shared shopping list 165 and notifications 170 received from the app provider 105. For example, when the user enters a store, the mobile shopping app 175 may retrieve an updated copy of the list 165 and then display it in the display 160 for the user to determine whether they will purchase any items on the list 165. Although not required, the app provider 105 can send the notifications 170 to inform the user when they have purchased an item that someone else wants from the shared shopping list 165, are close to an item on the list 165, or that the store has an item on the list 165 that is currently out-of-stock in many other stores (e.g., due to a natural disaster or supply chain issues). Various different techniques for pushing notifications 170 are discussed in FIG. 5 below.

In addition to including the virtual shopping cart 185, the mobile shopping app 175 also includes a notification module 180 for receiving the notifications 170 from the app provider 105 and outputting the notifications 170 on the display 160. Moreover, the notification module 180 can generate the notifications 170 at the mobile device 150, rather than receiving notifications from the app provider 105. For example, the notification module 180 can monitor the items being added to the cart 185 and then determine whether those items are also on the shared shopping list 165, and if so, output a notification 170. Or the notification module 180 can receive a location of the user device 150 (e.g., using GPS or Wi-Fi localization within a store) and use the location to determine when to generate the notifications 170.

In one embodiment, the mobile device 150 is a personal device of the user (where the user is a member of the shared shopping list 165) such as a mobile phone, tablet, etc. In another embodiment, the mobile device 150 may be provided by a store when the user enters the store (e.g., a retailer owned device). For example, the user may sign in to an account in order to access the shared shopping list 165.

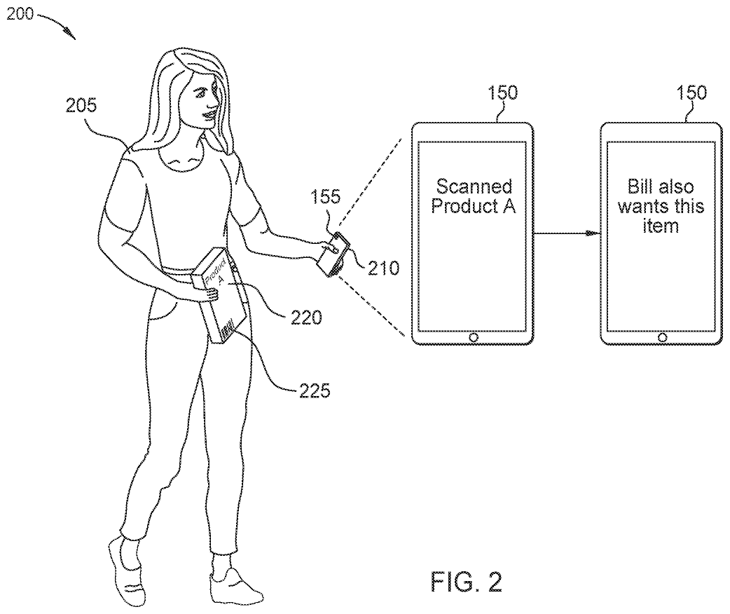

FIG. 2 depicts a second example environment 200, according to one embodiment. In one embodiment, the second example environment is in a store of a customer 205 participating in a mobile shopping experience. Customer 205 uses her mobile device 210 to do the mobile shopping. In one embodiment, the mobile shopping takes place through an application on the mobile device 210 (e.g., the mobile shopping app 175 in FIG. 1). The mobile device 210 has a camera 155. The camera 155 scans a product's barcode and takes an image of the product.

It is assumed the customer 205 is a member of the shared shopping list. In this example, the customer 205 uses the camera 155 to capture an image of the item 220 (i.e., Product A) and its barcode 225. In response, the mobile shopping app can identify the item 220 (e.g., by decoding the barcode 225 or by using a computer vision system to identify the item 220).

Once identified, the mobile shopping app outputs to the display on the mobile device 150 a confirmation that Product A was added to the virtual shopping cart (e.g., the cart 185 in FIG. 1) for the customer 205. The customer 205 can then review the confirmation to make sure the item 220 was correctly identified.

In addition to displaying the confirmation, the mobile shopping app can check whether Product A is also on the shared shopping list. Assuming it is, the mobile shopping app then displays a notification indicating “Bill also wants this item.” The customer 205 then knows that Bill also wants Product A, and has preauthorized her to purchase the item on his behalf. That is, if customer 205 scans another one of the item 220 and adds it to her cart, Bill will be directly charged for the item. Thus, customer 205 does not have to use her own funds to purchase a second one of the item 220 or go through a reimbursement process.

If the customer 205 scans another item 220, the mobile shopping app can also add it to the cart. The app may query the customer 205 to ask whether the recently scanned item 220 is for herself or for Bill. If for Bill, the app can use Bill's payment data to pay for the item when the user checks out (i.e., purchases the items in the virtual (and physical) shopping cart).

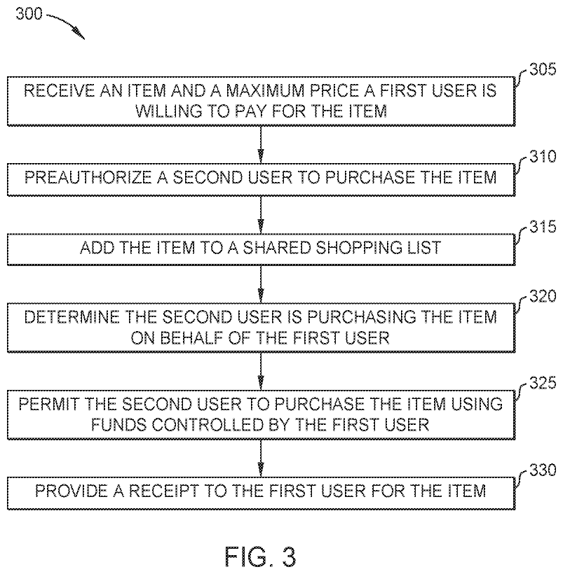

FIG. 3 is a flow diagram of a method 300 for purchasing preauthorized items from a shared shopping list. At block 305, app provider (e.g., the app provider 105 in FIG. 1) receives an item and a maximum price a first user is willing to pay for the item. For example, the first user may be a member of a shared shopping list. The first user may determine she is out of a particular item, and will not have time to pick up the item for several days. Or the first user may be at a store, but the desired item may be out of stock. Instead of going to multiple stores to find the item, she may add the item to the shared item list in hopes another member of the list may be at a store that does have the item in stock. Thus, the shared shopping list may be especially useful when items are difficult to find due to natural disasters or supply chain issues. A crowd sourcing approach enabled by the shared shopping list can be used to find the item. However, these are just a few examples in which the shared shopping list can be helpful.

The maximum price ensures another member of the shared shopping list does not purchase the item for more than the maximum price. However, this is optional. The user may not provide a maximum price for the item. Before permitting a second user to purchase the item for the first user, the mobile shopping app may ask the first user to confirm they are comfortable with the current price.

In one embodiment, the method 300 assumes the first user has provided a funding source (e.g., user payment data 110 in FIG. 1) for paying for the item. As discussed above, the funding source can be a credit card on file with a retailer, a checking account, a blockchain transaction, and the like.

At block 310, the app provider preauthorizes a second user to purchase the item. For example, the app provider may confirm the user payment data for the first user is up-to-date (the credit card on file has not expired), the user has not exceeded a credit allotment, and the like. In one embodiment, preauthorizing the second user to purchase the item means that funds controlled by the first user will be used to pay for the item if the second user adds the item to their virtual shopping cart and checkout.

At block 315, the app provider adds the item to the shared shopping list. In one embodiment, the app provider pushes out an update to local copies of the shared shopping list that are stored on user devices for the members of the shared shopping list. Or when the mobile shopping apps are opened on the user device, the apps may query the app provider to retrieve the most recent version of the shared shopping list. Thus, the members can update the shared shopping list in real-time and have those updates be pushed to the user devices of the other members.

At block 320, a mobile shopping app executing on a mobile device determines the second user is purchasing the item on behalf of the first user. Using FIG. 2 as an example, the customer 205 (e.g., the second user) can use the mobile device 150 to purchase the item 220 that is on the shared shopping list. The customer 205 can indicate to the mobile device 150 that the current item being added to the virtual cart is to satisfy a request for an item in the shared shopping list.

At block 325, the mobile shopping app permits the second user to purchase the item using funds controlled by the first user. For example, the mobile shopping app may use the user payment data for the first user to pay for the item.

At block 330, the mobile shopping app provides a receipt to the first user for the item. This receipt could be emailed, texted, or otherwise transmitted to the mobile device for the first user. Thus, the first user can know the item was purchased on their behalf. Further, if they wish to return the item, the first user has the receipt for returning the item.

The method 300 is not limited to any particular manner in which the second user can physically deliver the item to the first user. For example, the mobile shopping app can enable the first and second users to communicate to determine how to deliver the item to the first user.

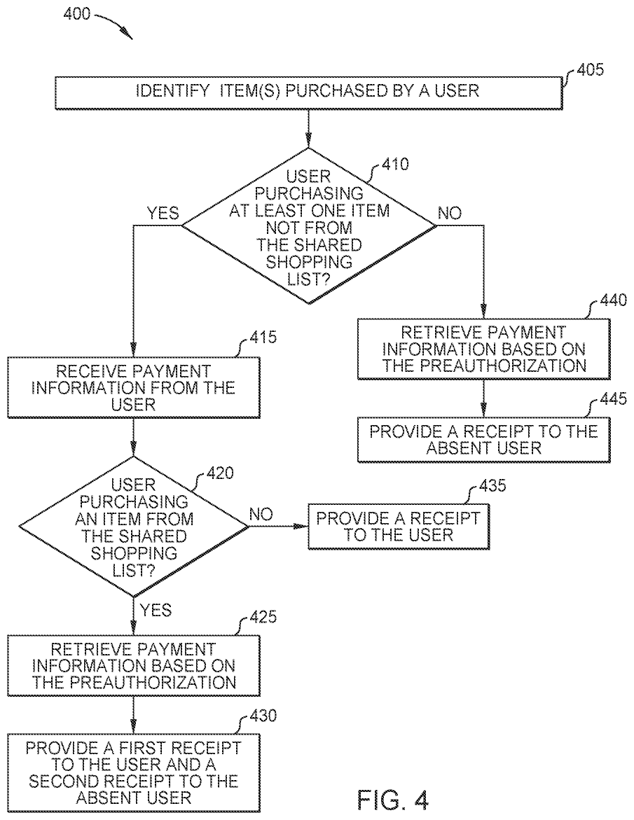

FIG. 4 is a flow diagram of a method 400 for providing receipts. At block 405, the mobile shopping app identifies at least one item being purchased by a user. For example, the user can tell the mobile shopping app he is ready to checkout and pay for the items in the virtual shopping cart.

At block 410, the mobile shopping app determines whether the user is purchasing an item not from the shared shopping list. That is, app determines whether the user is purchasing at least one item for himself rather than purchasing only items from the shared shopping list.

If so, the method 400 proceeds to block 415 where the mobile shopping app receives payment information from the user. In one embodiment, the user's payment data may be stored in user payment data at the app provider. In another embodiment, the user may provide a different form of payment to pay for his items in the virtual cart (e.g., entering in a credit card manually, paying with a gift card, proceeding to a physical self-checkout lane to pay with cash, etc.).

At block 420, the mobile shopping app determines whether the user is purchasing an item from the shared shopping list. That is, in addition to purchases on or more items for himself, the user may also purchase an item from the shared shopping list on behalf of someone else. If so, the method 400 proceeds to block 425 where the mobile shopping app retrieves payment information based on the preauthorization. This preauthorization may have been obtained at block 310 in FIG. 3. Thus, without having to receive any additional authorization from the “absent user”, the mobile shopping app can proceed to purchase the item using funds controlled by the absent user.

At block 430, the mobile shopping app provides a first receipt to the user and a second receipt to the absent user. That is, the mobile shopping app can generate a first receipt to the user who is at the store for the items he purchased for himself and a second receipt to the absent user. That way, the two users have separate receipts for items that were purchased using their respective funds. The receipts may be delivered to the two users using any suitable delivery method. For example, the first user may be able to print a receipt since he is at the store. For instance, the mobile shopping app may direct the user to a self-checkout lane where the receipt is printed. For the absent user, the second receipt may be delivered electronically such as being saved in a copy of the mobile shopping app on the mobile phone of the absent user or being emailed to the absent user. The first receipt can also be delivered electronically to the user who is present at the store.

Returning to block 420, if the user is not purchasing any items from the shared shopping list, the method 400 instead proceeds to block 435 where the mobile shopping app provides a receipt to the user for the item (or items) he purchased for personal use. As discussed above, this receipt could be physically printed at the store or delivered electronically. Since the user did not purchase any items for another member of the shared shopping list, no other receipt is needed.

Returning to block 410, if the user is not purchasing an item for himself, this means the only items being purchased are for another member of the shared shopping list. For example, the user may have gone to a store to pick up an item he wanted, but decided not to buy it because it was out of stock or the price was too high. In any case, the mobile shopping app may have notified the user that there was an item at the store that is on the shared shopping list. For example, the user may have wanted to purchase chicken, but the store did not have the type of chicken he wants. However, the app may have determined the user was in the meat aisle and sent a notification that a member of the shared shopping list (e.g., an absent user) wants pork chops. The user could have scanned the pork chops using the mobile device and proceeded to checkout.

At block 440, the mobile shopping app retrieves payment information based on the preauthorization. This block can be the same as block 425 where funds controlled by the absent user are used to pay for the item.

At block 445, the mobile shopping app provides a receipt to the absent user for the items that were purchased on behalf of the absent user by the user who is currently at the store. As discussed above, this receipt can be delivered electronically. In this case, no receipt is generated for the user at the store since he did not purchase any items for personal use.

FIG. 5 is a flow diagram of a method 500 for updating a shared shopping list. At block 505, the app provider receives payment information from each user (or member) of the shared shopping list. Block 505 may occur when the users open accounts on mobile shopping app, or when first attempting to create a group of members for a shared shopping list. Thus, block 505 may occur before any user has entered a store or attempted to purchase an item on behalf of another user of the shared shopping list.

As discussed above, the payment information can include a credit card, store credit, a gift card, a third-party payment application, blockchain information, and the like.

At block 510, the app provider establishes a shared shopping list for the users. This enables the users to add items to the list, which the app provider can then preauthorize to be purchased by the other users as discussed above.

At block 515, the users populate the shared list by adding items using their mobile devices or a web portal.

At block 520, the app provider, or a mobile shopping app stored on a user device, pushes notifications to one of the users when at a store regarding an item in the shared list. There are many different scenarios where the app provider or mobile shopping app may push a notification. For example, the user may have added to his virtual cart an item that is on the shared shopping list (which is the scenario illustrated in FIG. 2). In another example, the mobile shopping app may determine the user has entered a particular store, queried the store's inventory to learn whether it has a hard-to-find item on the shared shopping list (due to natural disaster or supply chain issues), and provide the notification to the user in the store. In another example, the mobile shopping app may determine that the current location of the user in a store (e.g., using GPS or Wi-Fi localization) is near an item on the shared shopping list (e.g., the user is within 10 feet of an item on the shared shopping list). In another example, the mobile shopping app may determine that the user added to his virtual shopping cart an item that is typically stocked near an item on the shared shopping list and push the notification (e.g., the user scanned chicken breasts and chicken wings are on the shared shopping list or the user scanned toilet paper and paper towels are on the shared shopping list). In that case, the mobile shopping app does not need to track the location of the user to still send geographically relevant push notifications.

At block 525, the app provider, or a mobile shopping app stored on a user device, pushes notifications to other users (e.g., absent users) that one of the users is at the store. In this case, rather than pushing notifications to the user at the store to purchase an item from the list, here the app provider or mobile shopping app pushes notifications to the user who are not currently at the store.

In one embodiment, the notification is triggered when the customer enters a store. For example, GPS can be used, or when the user associates with a store's Wi-Fi, to determine the particular store the user is entering and broadcast to the other members of the shared shopping list a notification. This might prompt the absent users to think of items they may want from that store, and quickly add them to the shared shopping list while the user is at the store.

In another embodiment, the push notification is triggered when the user first scans at item to add it to his virtual shopping cart. For example, the push notification to the other users may say: “Bill is at Store X and just bought chicken. Need anything?” Thus, the push notification can be sent without having to use GPS or Wi-Fi to track the location of the user.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the preceding features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages discussed herein are merely illustrative and are not considered elements or limitations of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

What is claimed is:

1. A method comprising:
receiving an item from a first user to add to a shared shopping list, wherein the first user and a second user are both able to add items to the shared shopping list;
preauthorizing the second user to purchase the item on behalf of the first user using funds controlled by the first user;
determining, after adding the item to the shopping list, the second user is purchasing the item on behalf of the first user while at a store; and
permitting, based on the preauthorization, the second user to purchase the item using the funds controlled by the first user.

2. The method of claim 1, wherein determining the second user is purchasing the item on behalf of the first user comprises:
capturing, using a camera in a mobile device, an image of the item;
identifying the item based on the image; and
adding the item to a virtual shopping cart managed by a mobile shopping application executing on the mobile device.

3. The method of claim 2, wherein the second user can purchase the item using the mobile shopping application without having to use a checkout kiosk in the store.

4. The method of claim 2, further comprising, before determining the second user is purchasing the item on behalf of the first user:
determining the second user has added a same item as the item in the shared shopping list to the virtual shopping cart; and
pushing a notification to a display of the mobile device indicating that the same item is also on the shared shopping list to prompt the second user to add the item to the virtual shopping cart and purchase the item on behalf of the first user.

5. The method of claim 2, further comprising, before determining the second user is purchasing the item on behalf of the first user:
determining the second user is at a location of the store proximate to the item on the shared shopping list; and
pushing a notification to a display of the mobile device prompting the second user to add the item to the virtual shopping cart and purchase the item on behalf of the first user.

6. The method of claim 5, wherein determining the second user is at the location of the store proximate to the item on the shared shopping list is based on at least one of: the second user adding a different item to the virtual shopping cart that is typically stocked near the item on the shared shopping list, or by tracking a location of the mobile device in the store.

7. The method of claim 1, further comprising:
providing a receipt for the item to the first user in response to the second user purchasing the item using the funds controlled by the first user, wherein the receipt is delivered electronically to the first user.

8. The method of claim 7, further comprising:
determining the second user has purchased a second item using funds controlled by the second user while at the store; and
providing a different receipt to the second user for the second item.

9. The method of claim 1, further comprising:
receiving a maximum price the first user is willing to pay for the item, wherein the second user is preauthorized to purchase the item on behalf of the first user for up to the maximum price.

10. The method of claim 1, further comprising:
determining the second user is at the store;
pushing notifications to mobile devices associated with a plurality of other users that are also able to add items to the shared shopping list that the second user is at the store, the notifications prompting the plurality of users to add items to the shared shopping list for the second user to purchase on their behalf while the second user is at the store.

11. A system, comprising:
one or more computer processors; and
a memory containing a program which when executed by the one or more computer processors performs an operation, the operation comprising:
receiving an item from a first user to add to a shared shopping list, wherein the first user and a second user are both able to add items to the shared shopping list;
preauthorizing the second user to purchase the item on behalf of the first user using funds controlled by the first user;
determining, after adding the item to the shopping list, the second user is purchasing the item on behalf of the first user while at a store; and
permitting, based on the preauthorization, the second user to purchase the item using the funds controlled by the first user.

12. The system of claim 11, wherein determining the second user is purchasing the item on behalf of the first user comprises:
capturing, using a camera in a mobile device, an image of the item;
identifying the item based on the image; and
adding the item to a virtual shopping cart managed by a mobile shopping application executing on the mobile device.

13. The system of claim 12, wherein the second user can purchase the item using the mobile shopping application without having to use a checkout kiosk in the store.

14. The system of claim 12, wherein the operation further comprises, before determining the second user is purchasing the item on behalf of the first user:
determining the second user has added a same item as the item in the shared shopping list to the virtual shopping cart; and
pushing a notification to a display of the mobile device indicating that the same item is also on the shared shopping list to prompt the second user to add the item to the virtual shopping cart and purchase the item on behalf of the first user.

15. The system of claim 12, wherein the operation further comprises, before determining the second user is purchasing the item on behalf of the first user:
determining the second user is at a location of the store proximate to the item on the shared shopping list; and
pushing a notification to a display of the mobile device prompting the second user to add the item to the virtual shopping cart and purchase the item on behalf of the first user.

16. The system of claim 11, wherein the operation further comprises:
providing a receipt for the item to the first user in response to the second user purchasing the item using the funds controlled by the first user, wherein the receipt is delivered electronically to the first user.

17. The system of claim 11, wherein the operation further comprises:
receiving a maximum price the first user is willing to pay for the item, wherein the second user is preauthorized to purchase the item on behalf of the first user for up to the maximum price.

18. A computer readable storage medium having computer-readable program code embodied therewith, the computer-readable program code executable by one or more computer processors to:
receive an item from a first user to add to a shared shopping list, wherein the first user and a second user are both able to add items to the shared shopping list;
preauthorize the second user to purchase the item on behalf of the first user using funds controlled by the first user;
determine, after adding the item to the shopping list, the second user is purchasing the item on behalf of the first user while at a store; and
permit, based on the preauthorization, the second user to purchase the item using the funds controlled by the first user.

19. The computer readable storage medium of claim 18, wherein determining the second user is purchasing the item on behalf of the first user comprises:
capturing, using a camera in a mobile device, an image of the item;
identifying the item based on the image; and
adding the item to a virtual shopping cart managed by a mobile shopping application executing on the mobile device.

20. The computer readable storage medium of claim 19, wherein the second user can purchase the item using the mobile shopping application without having to use a checkout kiosk in the store.
